(19) United States
(12) Patent Application Publication
(10) Pub. No.: US 2018/0077461 A1
(43) Pub. Date: Mar. 15, 2018

(54) ELECTRONIC DEVICE, INTERRACTIVE MEHOTD THEREFOR, USER TERMINAL AND SERVER

(71) Applicant: Morefun (Beijing) Technology Co., Ltd., Beijing (CN)

(72) Inventor: Pi LI, Beijing (CN)

(21) Appl. No.: 15/701,364

(22) Filed: Sep. 11, 2017

(30) Foreign Application Priority Data
Sep. 12, 2016 (CN) 201610819662.0
Jul. 17, 2017 (CN) 201710584631.6

(51) Int. Cl. H04N 21/472; H04N 21/20; H04N 21/65

(52) U.S. Cl. CPC H04N 21/472; H04N 21/65; H04N 21/20

(57) ABSTRACT

There is provided a control method and a control apparatus for an electronic device. The method comprises: establishing communication connection with another device; creating a transparent display layer above a display interface of the electronic device in response to the establishment of the communication connection; receiving interactive contents from the another device; and displaying the interactive contents in the transparent display layer. The method enables the another device to interact with the electronic device without affecting the broadcasting of contents that are originally displayed. Furthermore, special effects may arise due to the combination of the interactive contents and the contents that are originally displayed, leading to various types of interaction between the electronic device and the another device.

### CROSS-REFERENCE TO RELATED APPLICATIONS

This application claims the benefit and priority to Chinese patent applications No. 201610819662.0, filed on Sep. 12, 2016 and No. 201710584631.6, filed on Jul. 17, 2017. Both applications are incorporated herein in their entirety by reference.

### TECHNICAL FIELD

The disclosure relates to the interactive field of electronic devices, and in particular, to an electronic device, an interactive method, a user terminal and a server.

### BACKGROUND

In recent years, technologies for interaction of electronic devices have gained increasingly popularity. Taking electronic devices such as a smart TV and a set-top box (STB) as an example, DLNA, Miracast, Airplay or the like is usually used as transmission protocol in current interactive technologies, and a server, a smart terminal (e.g., a smart phone) or the like serves as an output end of video signals, while the smart TV or the STB serves as a receiving end of video signals, such that the smart TV can switch from displaying normal display signals (e.g., cable TV signals) to displaying the video signals from other devices. In this way, interaction of the other devices as above and the smart TV can be realized. However, the smart TV displaying normal signals will be interfered under such a case and the interaction mode is limited as well.

### SUMMARY

The objective of the present invention is to realize interaction with an electronic device without affecting the contents that are originally broadcasted by the electronic device so as to improve user experience.

According to one aspect of the present invention, an interactive method for an electronic device is provided, comprising: establishing communication connection of the electronic device with another device; creating, by the electronic device, a transparent display layer above a display interface of the electronic device; receiving interactive contents from the another device; and displaying the interactive contents in the transparent display layer.

According to another aspect of the present invention, an interactive method for an electronic device is provided, comprising: receiving, by a server, a verification request from the electronic device; verifying, by the server, whether the electronic device has been registered in response to the verification request; establishing, by the server, a communication connection with the electronic device in a case where the electronic device has being registered; and transmitting, by the server, interactive contents to the electronic device so that the interactive contents are displayed in a transparent display layer created above a display interface of the electronic device.

According to still another aspect of the present invention, provided is an electronic device, comprising: a first connection module, configured to establish communication connection with another device; a creation module, configured to create a transparent display layer above a display interface of the electronic device; a reception module, configured to receive interactive contents from the another device; and a display module, configured to display the interactive contents in the transparent display layer.

According to still another aspect of the present invention, provided is an user terminal for interacting with an electronic device, comprising: a second connection module, configured to transmit a connection request to the electronic device so as to establish communication connection with the electronic device; an acquisition module, configured to acquire interactive contents; and a transmission module, configured to transmit the acquired interactive contents to the electronic device so that the interactive contents are displayed in a transparent display layer created above a display interface of the electronic device.

According to still another aspect of the present invention, provided is a server for interacting with an electronic device, comprising: a reception module, configured to receive a verification request from the electronic device; a verification module, configured to verify whether the electronic device has been registered in response to the verification request; a third connection module, configured to establish a communication connection with the electronic device in a case where the electronic device has been registered; and a transmission module, configured to transmit interactive contents to the electronic device so that the interactive contents are displayed in a transparent display layer created above a display interface of the electronic device.

In an embodiment, the interactive contents are carried in a data packet that includes custom fields associated with the interactive contents so that the electronic device analyzes for the interactive contents.

### BRIEF DESCRIPTION OF DRAWINGS

The drawings, which are incorporated in and constitute part of the specification, together with the description, illustrate exemplary examples, features and aspects of the present invention and serve to explain the principles of the present invention.

FIG. 1 is a flow diagram illustrating an interactive method for an electronic device according to an embodiment of the present invention.

FIG. 2 is a flow diagram illustrating an exemplary example of an interactive method for an electronic device according to an embodiment of the present invention.

FIG. 3 is a flow diagram illustrating an interactive method for an electronic device according to an embodiment of the present invention.

FIG. 4 is a flow diagram illustrating an exemplary example of an interactive method for an electronic device according to an embodiment of the present invention.

FIG. 5 is a flow diagram illustrating an interactive method for an electronic device according to an embodiment of the present invention.

FIG. 6a-6b are diagrams illustrating structure of an electronic device according to an embodiment of the present invention.

FIG. 7 is a diagram illustrating structure of an exemplary electronic device according to an embodiment of the present invention.

FIG. 8 is a diagram illustrating structure of a mobile terminal for interacting with an electronic device according to an embodiment of the present invention.

FIG. 9 is a diagram illustrating structure of a server for interacting with an electronic device according to an embodiment of the present invention.

FIG. 10 is block diagram illustrating an electronic device according to an exemplary embodiment. FIG. 11 is a block diagram illustrating an electronic device according to an exemplary embodiment.

FIG. 12 is a schematic diagram illustrating system structure according to an application example of the present invention.

### DETAILED DESCRIPTION

Various exemplary examples, features and aspects of the present invention will be described in detail with reference to the drawings. The same reference numerals in the drawings represent parts having the same or similar functions. Although various aspects of the examples are shown in the drawings, it is unnecessary to proportionally draw the drawings unless otherwise specified.

Here the term “exemplary” means “used as an instance or example, or explanatory”. An “exemplary” example given here is not necessarily construed as being superior to or better than other examples.

Numerous details are given in the following examples for the purpose of better explaining the present invention. It should be understood by a person skilled in the art that the present invention can still be realized even without some of those details. In some of the examples, methods, means, units and circuits that are well known to a person skilled in the art are not described in detail so that the main points of the present invention become prominent.

### First Embodiment

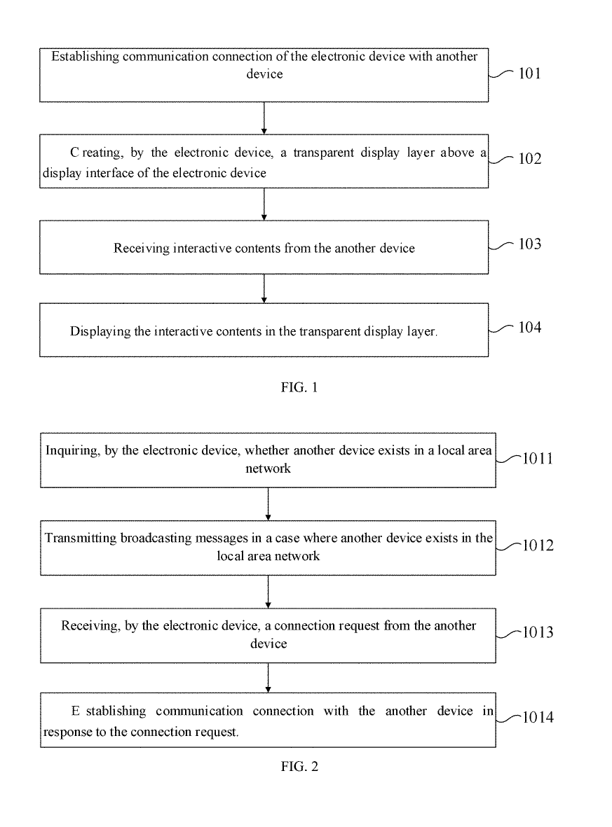

FIG. 1 is a flow diagram illustrating an interactive method for an electronic device according to the first embodiment of the present invention. The method is applicable to an electronic device which can broadcast video signal and can be connected with an external device for communication via network or other wired or wireless connections. For example, the electronic device may be an electronic broadcasting device such as a smart TV or an STB, or an electronic device that is capable of communication and display. For example, the method can be realized with software that is installed in an operating system (e.g., Android system) of a smart device such as the smart TV or the STB in the form of an installation package or a software development kit. Hereinafter, the smart TV or the STB is used as an example to explain the present embodiment and various exemplary embodiments thereof. As illustrated in FIG. 1, the method comprises steps 101 to 104.

In step 101, communication connection is established between the electronic device and another device. The another device can be any device that is to be interacted with the electronic device, and examples thereof include a terminal device such as a smart telephone and a tablet computer, and a server such as a cloud server. The establishment of the communication connection enables the another device to communicate with the electronic device. There is no limit to the specific way of establishing communication connection in the present invention.

In step 102, a transparent display layer is created above a display interface of the electronic device in response to the establishment of the communication connection. In other words, the transparent display layer, as “the top layer” (or “the outermost layer”), is located above (or outside) an original display layer of the display interface of the electronic device. The term “transparent” means that the screen of the electronic device presents the original display interface or contents that are originally broadcasted when the layer does not show anything. As a possible embodiment, a transparent display layer can be created like this: calling the underlying hardware of graphic processing unit by using the OpenGL interface, followed by a rendering processing. In addition, the transparent display layer may also be created on the display interface of the electronic device in response to creation request from another device.

In step 103, interactive contents from the another device are received by the electronic device. The “interactive contents” in the present application can be anything that can be displayed in the transparent display layer, such as images including static image or dynamic expression image, texts and videos, or any other things such as audios, control instructions, and the like.

In step 104, the interactive contents are displayed in the transparent display layer.

In this embodiment, a transparent display layer is created above a display interface of the electronic device in response to the establishment of the communication connection, and interactive contents from the another device are displayed in the transparent display layer. Because the interactive contents are displayed in the transparent display layer, which is the top layer, the interactive contents are actually superimposed on the original display interface of the electronic device. As a result, contents that are originally displayed on the display interface can still be broadcasted. That is, the electronic device can interact with the another device without having contents that are originally displayed affected. Besides, special effects may arise due to the combination of the interactive contents and the contents that are originally displayed, leading to various types of interaction between the electronic device and the another device. For instance, in a possible application scene, barrages can be transmitted to the smart TV with a telephone; the smart TV can display a PIP, or broadcast special pictures, sounds (e.g., the scene of water splashing, or applause sound), or the like.

Also in this embodiment, in response to the establishment of the communication connection, a “transparent interactive-contents screen”, which is realized with the transparent display layer, is appended to (or superimposed on) the outermost layer of the original display interface which displays, for example, the original TV signals so that interactive contents from the another device can be displayed. Therefore, in a case where no communication connection is established or no interaction takes place, the electronic device does not take up additional system resources. On this basis, in a possible embodiment, a GPU (graphic processing unit) can be used to render the interactive contents in the transparent display layer so that fewer system resources would be taken up.

FIG. 2 is a flow diagram illustrating step 101 in an exemplary interaction method for an electronic device according to an embodiment of the present invention. As shown in FIG. 2, step 101 comprises steps 1011 to 1014.

In step 1011, inquiring is made about whether another device in the local area network exists;

In step 1012, broadcasting messages are transmitted in a case where another device exists in the local area network;

In step 1013, a connection request from the another device is received; and

In step 1014, communication connection with the another device is established in response to the connection request.

At present, main protocols for LAN device discovery, e.g., SSDP and MSDN, all require the electronic device to transmit UDP broadcasting over the LAN at regular time, which, to some extent, delays the discovery of devices. This example contains an active discovery mechanism by which the electronic device is capable of searching for other devices within the network on its own initiative. Consequently, other devices can be found at a quicker pace, thereby optimizing user experience. In a possible embodiment, it is favorable to introduce another device (e.g., a terminal device) that is capable of transmitting broadcasting messages on its own initiative so that the electronic device can find other devices easier. Alternatively, the electronic device can determine whether an available cloud server exists within the network by inquiring about sites of cloud servers.

Correspondingly, in a possible embodiment, the established communication connection can be disconnected in response to a disconnection request from another device or to a condition set in the electronic device itself.

In a possible embodiment, interactive contents can be transmitted via a data packet that can include custom fields associated with the interactive contents. The electronic device can analyze the received interactive contents based on the custom fields and display the analyzed interactive contents in the transparent display layer.

In other words, according to an embodiment of the present invention, it is possible to define a private protocol for transmission between the electronic device and other devices. The private protocol may be different from conventional protocols such as DLNA, Miracast and Airplay. In addition to having a permanent information header, the private protocol may reserve custom fields that may be associated with the interactive contents by, for example, indicating file format, size, encoding method of the interactive contents, or specifying a display mode and an analytic method thereof, thereby making it convenient for the electronic device to analyze the interactive contents as well as transmitting various types of information (e.g., image, text, audio, video, and control instruction).

For example, the electronic device may display, in accordance with the custom fields, the interactive contents from the another device at a designated location of the screen in a designated size at a designated time, or analyze, in accordance with a locally stored correspondence, the interactive contents into corresponding specific display contents.

For example, conventional DLNA protocol consists of 7 levels and each of the levels is fixed, so only invariable forms are acceptable to the DLNA protocol. Thus, the electronic device merely permits basic operations such as turning on/off a video, adjusting volume, fast-forward/-backward. That is also true with Miracast, Airplay and the like.

According to this example, it is possible to reserve multiple custom fields (having, for example, 32 bytes, or any number of bytes) besides a fixed information header specifying the transmission protocol, the admissible WIFI types, etc. The developer may add, to the custom fields, desirable information which the electronic device analyses to display the interactive contents or to realize additional control, and thereby enabling other manipulations such as game screen control. The game “roll the dice” is taken as an example. The user rocks his mobile telephone and rocking power is then analyzed by the mobile phone. The field “power”, for example, is included in the custom fields, and numeral values representing degrees of power are assigned to the field. The TV determines a rotation speed and a rotation time of the dice by analyzing the field, and then displays them in the transparent display layer.

In a possible embodiment, the method may further comprise: acquiring features of contents that are being broadcasted in the display interface of the electronic device, determining a current occupation of system resources of the electronic device, and adjusting the way of displaying the interactive contents in accordance with the occupation of the system resources. For example, the method may comprise: analyzing interactive contents transmitted by a mobile device such as a cloud server or a mobile telephone so as to find out formats (e.g. an audio, a video, an image or a text) of the interactive contents; acquiring features of contents (e.g. audio volume or video code stream of pictures of cable TV signals) that are being broadcasted using a hardware interface of the electronic device (e.g., a smart TV's hardware interface for cable TV signals); determining a current occupation of system resources of the electronic device, based on, for example, a pre-set correspondence between features and percentages of the system resources that are occupied; and automatically adjusting the way of displaying the interactive contents in accordance with the occupation percentage of the system resources, by, for example, regulating the definition for displaying the image or the video (e.g., lowering the definition in the case of a high occupation percentage) or changing the volume (e.g., lowering the volume in the case of a high take-up percentage, e.g. 80%). In this way, the contents currently broadcasted in the electronic device can merge with the interactive contents, thereby occupying fewer system resources of the electronic device.

### Second Embodiment

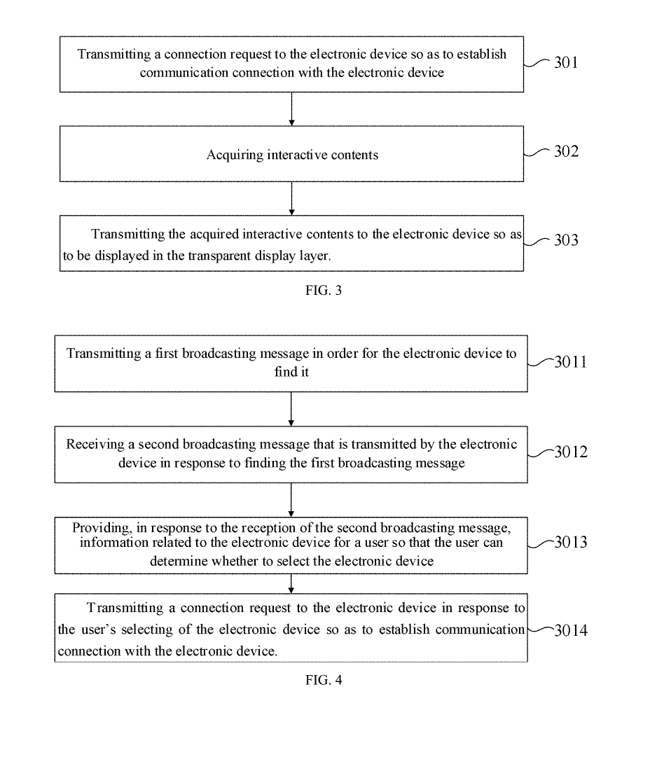

FIG. 3 is a flow diagram illustrating an interactive method for an electronic device according to another embodiment of the present invention. The method is applicable to a terminal device (e.g., a smart telephone, a tablet computer, and the like). For example, the method can be realized with software installed in an operating system (e.g., Android system, IOS system, and so on) of the terminal device in the form of a mobile APP integrated with SDK. As shown in FIG. 3, the method comprises steps 301 to 303.

In step 301, a connection request is transmitted to the electronic device so that communication connection with the electronic device is established.

In step 302, interactive contents are acquired.

In step 303, the acquired interactive contents are transmitted to the electronic device so that they can be displayed in a transparent display layer created above a display interface of the electronic device.

This embodiment enables the interactive contents to be provided to the electronic device and be displayed in a transparent display layer above a display interface thereof, thus enabling the another device to interact with the electronic device without affecting the broadcasting of contents that are originally displayed. Furthermore, special effects may arise due to the combination of the interactive contents and the contents that are originally displayed, leading to various types of interaction between the electronic device and the another device.

In a possible embodiment, various types of interactive contents can be acquired in multiple ways. For instance, interactive contents may be those that are stored in a terminal device, or received or collected in real time by a terminal device via a network or with a collection part—e.g., audios, videos, images, and the like, and are then directly displayed in a designated manner on the electronic device. Other examples of interactive contents include: instruction information generated in a user's operating of a terminal device (by operating, for example, a physical button or a touch screen control, or through voices, or the like); text messages input by a user at a terminal device, e.g., barrages; and information generated by a user's rocking a terminal device or generated by a terminal device in capturing a user's gestures or postures. The aforementioned information may be analyzed into specific audio, video, text, or the like in accordance with previous agreement, and hence broadcasted via the transparent layer.

As stated above, in a possible embodiment, interactive contents can be transmitted via a data packet that can include custom fields associated with the interactive contents so that the electronic device can analyze the interactive contents.

FIG. 4 is a flow diagram illustrating an exemplary interactive method for an electronic device according to another embodiment of the present invention. As shown in FIG. 4, step 301 comprises steps 3011 to 3014.

In step 3011, a first broadcasting message is transmitted in order for the electronic device to find it;

In step 3012, a second broadcasting message is received that is transmitted by the electronic device in response to finding the first broadcasting message;

In step 3013, information related to the electronic device is provided to a user in response to the reception of the second broadcasting message so that the user can determine whether to choose the electronic device; and

In step 3014, a connection request is transmitted to the electronic device in response to the user's choosing the electronic device so that communication connection with the electronic device can be established.

As stated above, the terminal device may transmit a broadcasting message so that the electronic device can find the terminal device on its own initiative and release the broadcasting message. The terminal device may receive broadcasting messages from one or more electronic devices, and a user may select among the electronic devices. The terminal device may transmit a connection request to the selected electronic device so as to establish communication connection with the electronic device. Such a “mutual finding” mechanism makes the finding more efficient.

It has to be explained that a user terminal may be connected with different electronic devices at the same time, and a transparent display layer can be created on different electronic devices (e.g. TV sets connected to a same local area network), so that the interactive contents can be displayed on each of these transparent layers. For example, a user may invite other users who have same hobbies, for example, to watch a same TV program, and a transparent display layer is similarly created above TV set of the invited user, so that the interactive contents can be synchronously displayed on the TV set of the invited user. In addition, other users who accept the invitation can transmit interactive contents to their respective TV set, and the multiple users are cable of watching the interactive contents by their respective TV set, so that the multiple users can interact with each other. For example, different users can interact with each other by delivering comments on performances of football players in a football contest via the transparent display layer created above their own TV sets.

### Third Embodiment

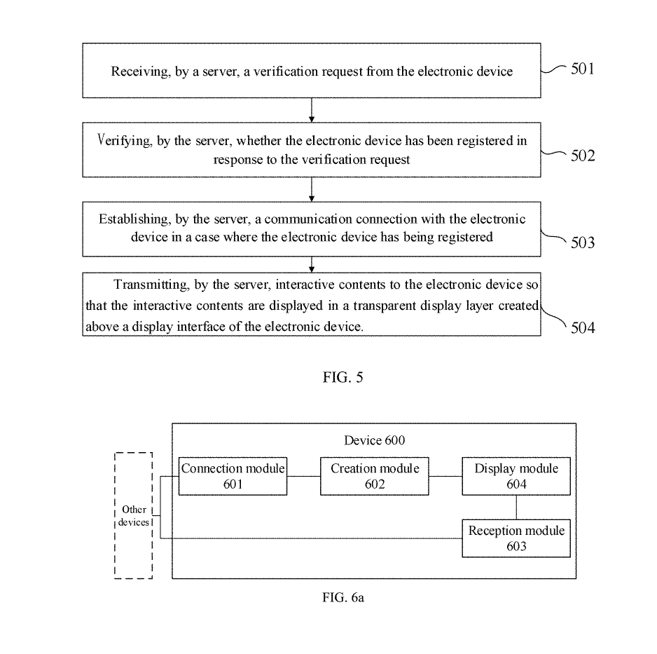

FIG. 5 is a flow diagram illustrating an interactive method for an electronic device according to still another embodiment of the present invention. This method is applicable to a server (e.g., a cloud server), and can be installed, for example, in an operating system of the server in the form of software. As shown in FIG. 5, this method includes steps 501 to 504.

In step 501, a verification request from an electronic device is received, and the request may be carried in a broadcasting message from the electronic device;

In step 502, verification is made, in response to the verification request, as to whether the electronic device has been registered;

In step 503, communication connection with the electronic device is established in response to a case where the electronic device has been registered; and

In step 504, interactive contents are transmitted to the electronic device so that they are displayed in a transparent display layer created above a display interface of the electronic device.

According to this embodiment, a cloud server or the like may be connected to a networked and registered electronic device; after connection is successful, interactive contents can be transmitted to the electronic device so that they can be displayed in the transparent display layer created above the display interface of the electronic device.

In a possible embodiment, as stated above, interactive contents can be carried in a data packet that includes custom fields associated with the interactive contents so that the electronic device can conveniently analyze the interactive contents.

### Fourth Embodiment

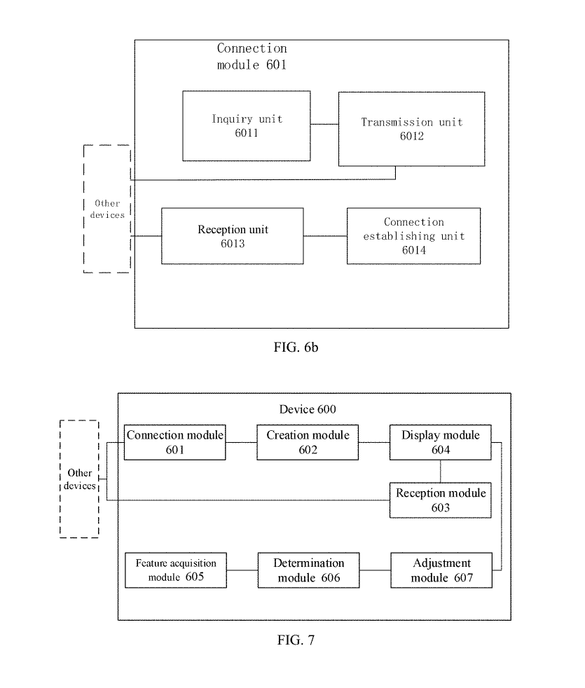

FIG. 6a-6b are diagrams illustrating an electronic device according to an embodiment of the present invention. The device is capable of performing the processes and functions of the method of the first embodiment. See the first embodiment for the corresponding explanations. The device may be an electronic broadcasting device such as a smart TV or an STB, or other smart device that is capable of communication and display. For example, an electronic device having corresponding functions can be obtained by installing software in an operating system (e.g., Android system) of an electronic device such as a smart TV or an STB in the form of an installation package or a software development kit.

As shown in FIG. 6a, the device 600 comprises: a connection module 601 configured to establish communication connection with another device; a creation module 602 configured to create a transparent display layer above a display interface of the electronic device in response to the establishment of the communication connection; a reception module 603 configured to receive interactive contents from the another device; and a display module 604 configured to display the interactive contents in the transparent display layer.

See FIG. 6b, in an example, the connection module 601 may comprise: an inquiry unit 6011 configured to inquire about whether another device exists in the local area network; a transmission unit 6012 configured to transmit a broadcasting message in a case where another device exist; a reception unit 6013 configured to receive a connection request from the another device; and a connection establishing unit 6014 configured to establish communication connection with the another device in response to the connection request.

In an example, the interactive contents can be carried in a data packet that includes custom fields associated with the interactive contents.

In an example, the display module 604 may comprise: an analytic unit configured to analyze the received interactive contents in accordance with the custom fields; and a display unit configured to display the analyzed interactive contents in the transparent display layer.

In an example, the display module 604 may use a GPU to render the interactive contents in the transparent display layer.

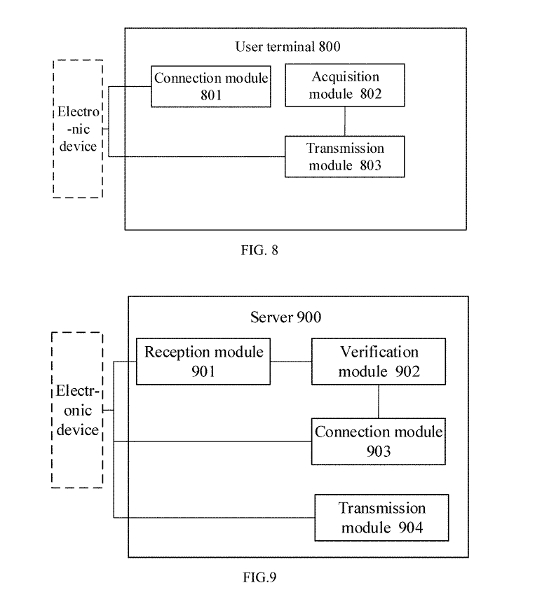

FIG. 7 is a diagram showing the structure of an exemplary electronic device according to an embodiment of the present invention. In this example, the device with respect to the example illustrated in FIG. 6a and FIG. 6b may further comprises: a feature acquisition module 605 configured to acquire features of contents that are being broadcasted in the display interface of the electronic device; a determination module 606 configured to determine a current take-up situation of system resources of the electronic device based on the features; and an adjustment module 607 configured to adjust the way of displaying the interactive contents in accordance with the take-situation of the system resources.

In this embodiment, for example, if the take-up percentage of the system resources is greater than 80%, images and/video displayed in the transparent display layer may be lowered, and/or size of the displayed image may be reduced, and/or size of the transparent display layer may be reduced, and/or volume of the interactive contents display in the transparent display layer may be lowered. For example, nature of contents being broadcasted may be adjusted according to frequency of interactive contents transmitted in the transparent display layer and take-up situation of system resources by contents that are currently broadcasted in the display interface of the electronic device. For example, whether a user is frequently interacting with the electronic device can be determined by data size (in an unit time) and/or type, etc., of interactive contents. If it is confirmed that the user is frequently interacting with the electronic device, a detection is performed that the take-up situation of system resources by the contents originally broadcasted in the display interface. If the system resources has been taken up with a high percentage(for example, more than 80%), volume and/or definition of the original contents may be reduced so as to allocate a part of system resources for the user to interact with the electronic device, hence improving user's interactive experience. On the contrary, if the interaction between the user and the electronic device becomes less, volume and/or definition of the contents originally displayed in the interface of the electronic device can be increased correspondingly. A user's interactive experience may be effectively enhanced by dynamically adjustment of the interactive contents and the contents originally displayed in the interface of the electronic device.

In another example, the electronic device may be provided with a statistic module for counting interactions (e.g. by calculating interactive data size or data type) of different user terminals (for example, user terminals used by different users in a same family) with the electronic device after the communication connection is established, so that an average value of the interaction frequency can be obtained. The take-up situation of system resources can be correspondingly calculated according to the average value, so that the electronic device can automatically allocate a system resources for the user to interact with the electronic device when a same user terminal is registered and interact with the electronic device, allowing the user to quickly involve in an interactive experience with the electronic devices such as a TV set. On this basis, the statistic module can count interactive time, involved interactive programs, interactive modes(such as text, picture, dynamic expression) of different user terminals, so that the statistic module can send connection instruction to the connection establishing module and creation instruction to the creation module when a user watch or detect the same program again, so that the TV set can automatically connect the user terminals and create a transparent display layer, hence allocating a proper system resources for interaction. It should be appreciated that statistic conclusion may be constantly adjusted and updated so as to adapt to possible change of user's interests. Both of video and interaction contents could be smoothly displayed by adjusting definition and/or volume of video displayed originally and by automatically adjusting allocation of system resources for different user terminals, therefore greatly improving user's experience.

In an embodiment, the interactive contents may comprise at least one of an image, a text, an audio, a video, and a control instruction.

### Fifth Embodiment

FIG. 8 is a diagram showing the structure of a user terminal for interaction with an electronic device according to another embodiment of the present invention. The user terminal is capable of performing the processes and functions of the method of the second embodiment. See the second embodiment for the corresponding explanations. The user terminal may be a smart telephone, a tablet computer, and the like. For example, such kind of user terminals can be obtained by installing software in an operating system (e.g., Android system, IOS system, and so on) of a terminal device in the form of a mobile APP integrated with SDK.

As shown in FIG. 8, the user terminal 800 comprises: a connection module 801 configured to transmit a connection request to the electronic device so as to establish communication connection with the electronic device; an acquisition module 802 configured to acquire interactive contents; and a transmission module 803 configured to transmit the acquired interactive contents to the electronic device so as to display them in a transparent displayer above the display interface of the electronic device.

In an embodiment, the acquisition module may comprise at least one of: a first acquisition unit configured to acquire contents stored in a terminal device; a second acquisition unit configured to acquire contents that are collected or received by a terminal device in real time; a third acquisition unit configured to acquire instruction information generated by a user's operating a terminal device; a fourth acquisition unit configured to acquire a text message input by a user at a terminal device; a fifth acquisition unit configured to acquire information generated by a user's rocking a terminal device; and a sixth acquisition unit configured to acquire information generated by a terminal device in capturing a user's gestures or postures.

In an embodiment, the interactive contents may be carried in a data packet that includes custom fields associated with the interactive contents so that the electronic device can conveniently analyze the interactive contents.

In an embodiment, the connection module may comprise: a first transmission unit configured to transmit a first broadcasting message in order for the electronic device to find it; a first reception unit configured to receive a second broadcasting message that is transmitted by the electronic device in response to finding the first broadcasting message; a supply unit configured to supply related information of the electronic device to a user in response to the reception of the second broadcasting message in order for the user to determine whether to choose the electronic device; and a second transmission unit configured to transmit a connection request to the electronic device in response to the user's choosing the electronic device so as to establish communication connection with the electronic device. Efficiency of finding the other by one of, for example, the electronic device and the user terminal, will be increased due to the mutual-finding design in the present application

### Sixth Embodiment

FIG. 9 is a diagram showing the structure of a server for interacting with an electronic device according to still another embodiment of the present invention. The server is capable of performing the processes and functions of the method of the third embodiment. See the third embodiment for the corresponding explanations. The server may be, for example, a cloud server. Such server can be obtained, for example, by installing a software in an operating system of a server.

As shown in FIG. 9, the server 900 comprises: a reception module 901 configured to receive a verification request from the electronic device; a verification module 902 configured to verify whether the electronic device has been registered in response to the verification request; a connection module 903 configured to establish communication connection with the electronic device in a case where the electronic device has been registered; and a transmission module 904 configured to transmit interactive contents to the electronic device so that they are displayed in a transparent display layer created above a display interface of the electronic device.

In an embodiment, the interactive contents can be carried in a data packet that includes custom fields associated with the interactive contents so that the electronic device can conveniently analyze the interactive contents.

### Seventh Embodiment

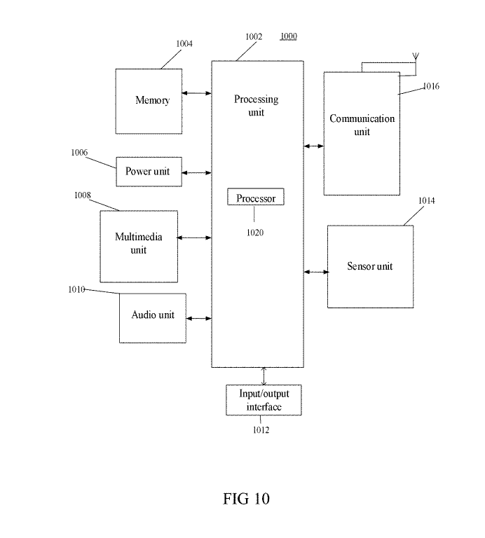

FIG. 10 is a block diagram exemplarily illustrating an electronic device according to an embodiment of the present invention. For example, device 1000 can be a mobile phone, a computer, a digital broadcasting terminal, a message transmission-reception device, a game control platform, a tablet device, a medical device, a body fitness device, a personal digit assistant and a smart device, etc.,

Referring to FIG. 10, the device 1000 may comprise any one or a plurality of: a processing unit 1002, a storage 1004, a power unit 1006, a multimedia unit 1008, an audio unit 1010, an input/output interface 1012, a sensor unit 1014 and a communication unit 1016.

The processing unit 1002 usually controls integrated operation of the device 1000, such as operations associated with display, telephone call, digital communication, camera operation and record operation. The processing unit 1002 may comprise one or a plurality of processors 1020 for performing execution of instructions so as to complete all or a part of steps of the above methods. Additionally, the processing unit 1002 may comprise one or a plurality of modules, so that the processing unit 1002 interacts with other units. For example, the processing unit 1002 may comprise a multimedia module such that a multimedia unit 1008 interacts with the processing unit 1002.

The storage 1004 is configured to store all kinds of data so as to support operation of the device 1000. Examples of data include instructions of any application program or method operated on the device 1000, contact data, messages, pictures, and videos, etc. The memory 804 may be realized by any one or combination of volatile memory and non-volatile memory, such as static random access memory (SRAM), electrically erasable programmable read-only memory (EEPROM), erasable programmable read-only memory (EPROM), programmable read only memory (PROM), read-only memory (ROM), magnetic memory, flash memory, magnetic disk or optical disk.

The power unit 1006 is configured to supply electrical power for units of the device 1000. The power unit 1006 can include power source management system, one or a plurality of powers, and other units associated with generation, management, allocation of power for the device 1000.

The multimedia 1008 unit comprises a screen providing an output interface between the device 1000 and a user. In some embodiments, the screen can include liquid crystal display or a touch panel. The screen comprising a touch panel is a touch screen which receives input signal from a user. The touch panel includes one or a plurality of touch sensor so as to sensing gesture applied on the touch panel such as touching or sliding. The touch sensor detects boundaries of a touching or sliding operation, and also detects duration time or pressure associated with the touch or sliding operation. In some embodiments, the multimedia unit 1008 comprises a front camera and/or a rear camera. When the device 1000 is in operation mode such as photographing mode or video mode, the front camera and/or rear camera may receive external multimedia data. Each front camera and a rear camera can be a fixed optical lens system or have a focus length and optical zoom capability.

The audio unit 1010 is configured to output and/or input audio signal. For example, the audio unit 1010 includes a microphone. When the device 1000 is in operation mode such as calling, recording and voice recognition, the microphone is configured to receive external audio signal. The received audio signal can be further stored in the memory 804 or transmitted via the communication unit 1016. In some embodiment, the audio unit 1010 further includes a loudspeaker for outputting audio signal.

The I/O interface is configured to supply interface between the processing unit 1002 and periphery interfaces 1002. The periphery interface 1002 can be a key board, a click wheel, a button, etc. These buttons include but not limited to: a homepage button, a volume button, a start button, a locking press button, etc.

The sensor unit 1014 comprises one or a plurality of sensors, being configured to evaluate the device 1000. For example, the sensor unit 1014 can detect on/off state of the device 1000, relative position of the units. For example, the unit can be a display or a small keyboard of the device 1000. The sensor unit 1014 can detect position change or any unit of the device 1000, whether a user contacts with the device 1000, azimuth or acceleration/deceleration as well as temperature variation of the device 1000. The sensor unit 1014 can include a proximity detector configured to detect the existence of a near object when no physical contact exists. The sensor unit 1014 may also include an optical sensor such as a CMOS or CCD image sensor, which is used in an imaging application. In some embodiments, the sensor unit 1014 can further include an accelerator, a gyro sensor, a magnetic sensor, a pressure sensor or a temperature sensor.

The communication unit 1016 is configured to provide convenience for wired or wireless communication between the device 1000 and other devices. The device 1000 can access to a wireless network based on communication standard such as WiFi, 2G or 3G, or their combination. In an exemplary example, the communication unit 1016 receives broadcasting signal or relevant message from external broadcasting management system via broadcasting channel. In an example, the communication unit 1016 further comprises near field communication (NFC) module to facilitate dedicated short range communication. For example, the NFC module may be realized based on radio frequency identification (RFID) technology, infrared data association (IrDA) technology, ultra wide band (UWB) technology, blue teeth (BT) technology and other possible technologies.

In an exemplary embodiment, the device 1000 may be realized by one or a plurality of application-specific integrated circuits (ASIC), data signal processors (DSP), digital signal processing devices (DSPD), programmable logic devices (PLD), field programmable gate arrays (FPGA), controllers, micro controllers, microprocessors or other electronic elements, so that the device can perform the method of the first embodiment or the second embodiment.

In an exemplary embodiment, provided is a non-temporary computer-readable storage media such as the memory 1004which comprises instructions. The instructions can be executed by the processor 1020 of the device 1000 to complete the above method. For example, the non-temporary computer-readable storage media can be read-only memory (ROM), random access memory (RAM), CD-ROM, magnetic tape, soft disk or optical data storage device.

### Eighth Embodiment

FIG. 11 is a block diagram illustrating a server interacting with an electronic device according to an exemplary embodiment. For example, the server 1900 can be a smart device or a cloud server. Referring to FIG. 11, the server 1900 comprises a processing unit 1922, which further comprises one or a plurality of processors and memory resources represented by the memory 1932. The memory resources are used for storing instructions (e.g. application program) that can be executed by the processing unit 1922. The application program stored in the memory 1932 may include one or more modules with each corresponding to a group of instructions. In addition, the processing unit 1922 is configured to execute the instructions so as to realize the method of the first and third embodiment.

The server 1900 can further include one or a plurality of power units 1926 that is configured to perform power management of the server 1900. One or more wired or wireless network interfaces 1950 are configured to connect the server 1900 to a network. The server 1900 also comprises one or more input/output (I/O) interfaces 1958, one or more keyboard 1956, and/or one or more operating system 1941. The server 1900 may execute a operation system stored on the memory 1932, such as Windows Server™, Mac OS X™, Unix™, Linux™, Free BSD™ or the like.

In an example, provided is a non-temporary computer read-only storage media. The instructions stored in the storage media may be executed by a processor of an electronic device, a terminal device or a server, so that the electronic device, the terminal device or the server can realize the method of the first, second and third embodiment.

### APPLICATION EXAMPLE

In order that the present invention is better understood, an exemplary application example is provided hereinafter. A person skilled in the art knows that this application example is not intended to limit the present in any sense.

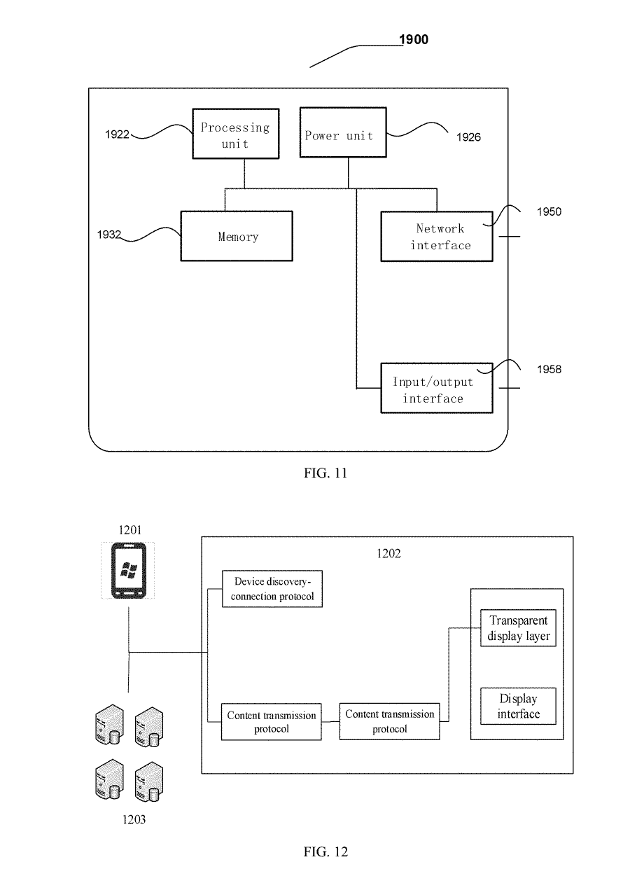

FIG. 12 is a system structure diagram according to an application example of the present application. A terminal device, e.g. cell phone, and the electronic device 1202(such as a smart TV or a STB) can be located within a same local area network by a router, so that interactive contents can be transmitted to the electronic device. Additionally, a server represented by the cloud server 1203 can be connected to the electronic device 1202 via internet so that interactive contents can be transmitted to the electronic device. The electronic device can support content transmission protocol, content output protocol and device discovery-connection protocol. The cell phone can support the content transmission protocol and device discovery-connection protocol. The cloud can support content transmission protocol and device discovery-connection protocol. So that various operations and functions in the embodiment as above can be realized.

In an application scene, when a cloud or a terminal device supporting above protocols is to transmit interactive contents to an electronic device, the device discovery-connection protocol may be employed to discover and connect the electronic device. On the basis that the device is already connected, the electronic device can create a transparent display layer and a cloud or a terminal device may transmit interactive contents of various formats to the electronic device on the basis of a content transmission protocol. The electronic device can analyze and integrate these interactive contents so as to adapt to traditional TV signal, hence the interactive contents can then be displayed on the transparent display layer.

The electronic device both displays images or sound displayed originally and interactive contents received from a cloud server or a terminal device in a transparent display layer, so that multiple interactions can be realized without influencing originally displayed contents.

In an exemplary application scene, a sports contest is being broadcasted via a smart TV, for the contents of the sports contest, a user can input text comments or send virtual property for convening expressions or deliver sound such as applaud or splashing. These text messages or property message, etc., can be transmitted to a smart TV via content transmission protocol. Specific contents of text or expression or numbers, etc., can be analyzed by the smart TV. Texts or expressions with a definition based on the features such as code stream currently displayed on TV are displayed in the transparent display layer above the interface of the smart TV that is lively broadcasting the sports contest, therefore realizing interaction between the user and the sports contest.

In another exemplary application scene, a sports contest is being broadcasted via a smart TV, a first user and a second user watch this contest via smart TV of their own. The first user has a first electronic device (user terminal) such a cellphone, a tablet computer. Similarly, the second user has a second electronic device (user terminal) such as a cellphone, a tablet computer. Both of the first user and the second user can access to their smart TVs with their terminals, so as to send text messages and virtual properties that can represent their mood to transparent display layers, which are created by the smart TV of their own, above the interface of their TVs broadcasting the sports contest respectively. Besides, these messages can be synchronized in the server. The server then confirms the smart TV that is connected with the server and allows these messages to be synchronously displayed in the transparent display layer of the smart TV that is connected to the server. Therefore, the multiple users can interact with each other through the transparent display layer of their own TVs in response to a particular TV program.

In the second exemplary application scene, a server is employed to allow messages to be synchronized in the networked smart TVs, however, it is also viable that two or more smart TVs being linked to a same local area network or internet such that interaction could be realized by their transparent display layers with mutually synchronized messages. Under such a case, for example, the first user can send connection request to the second user, and after reception, the smart TV of the second user can be connected to the smart TV of the first user so that the first user 1 can confirm whether the second user is watching the same program. If so, the message displayed in the transparent display layer of the smart TV of the first user is synchronously displayed on the TV of the second user, specifically on the transparent display layer created above the interface of the TV of the second user. The mode of which a transparent display layer is created by the smart TV of the second user may be the same as that of the smart TV of the first user. It is to be known by a person skilled in the art the above function can be realized by installing corresponding application software in smart TVs and cellphones of the first user and the second user respectively.

What is described above is merely the specific implementations of the present invention, hence the protection scope of the present invention is not limited by the description. Any variation or replacement that is easily to a technical person who is familiar with the technical field, within the technical scope disclosed in the present invention, shall be covered in the protection scope of the present invention. The protection scope of the present invention is defined by the claim.

What is claimed is:

1. An interactive method for an electronic device, comprising:
establishing communication connection of the electronic device with another device;
creating, by the electronic device, a transparent display layer above a display interface of the electronic device;
receiving interactive contents from the another device; and
displaying the interactive contents in the transparent display layer.

2. The interactive method for the electronic device according to claim 1, wherein creating the transparent display layer by the electronic device is performed in response to establishing communication connection of the electronic device with another device.

3. The interactive method for the electronic device according to claim 1, wherein creating the transparent display layer by the electronic device is performed on the basis of a creating request transmitted by the another device.

4. The interactive method for the electronic device according to claim 1, wherein establishing communication connection with the another device comprises:
inquiring, by the electronic device, whether another device exists in a local area network;
transmitting a broadcasting message under a case where another device exists in the local area network;
receiving, by the electronic device, a connection request from the another device; and
establishing communication connection with the another device in response to the connection request.

5. The interactive method for the electronic device according to claim 1, wherein the interactive contents are carried in a data packet that comprises custom fields associated with the interactive contents.

6. The interactive method for the electronic device according to claim 1, wherein displaying the interactive contents in the transparent display layer comprises:
analyzing, by the electronic device, the received interactive contents based on the custom fields, and
displaying the analyzed interactive contents in the transparent display layer.

7. The interactive method for the electronic device according to claim 1, wherein the electronic device comprises an image processing unit, and displaying the interactive contents in the transparent display layer comprises:
using the image processing unit to render the interactive contents in the transparent display layer.

8. The interactive method for the electronic device according to claim 1, further comprising:
acquiring features of contents that are being broadcasted in the display interface of the electronic device;
determining a current take-up situation of system resources of the electronic device based on the features; and
adjusting a way of displaying the interactive contents in accordance with the current occupation of the system resources.

9. The interactive method for the electronic device according to claim 8, wherein adjusting the way of displaying the interactive contents in accordance with the occupation of the system resources comprises: allowing the interactive contents to be displayed ambiguously or reducing a size of the transparent display layer when greater than 80% of the system resources is occupied.

10. An interactive method for an electronic device, wherein the electronic device comprises a display interface and a transparent display layer created on the display interface, the interactive method comprising:
transmitting a connection request to the electronic device so as to establish communication connection with the electronic device;
acquiring interactive contents; and
transmitting the acquired interactive contents to the electronic device so as to be displayed in the transparent display layer.

11. The interactive method for the electronic device according to claim 10, wherein acquiring the interactive contents comprises at least one of:
acquiring contents stored in a terminal device;
acquiring contents that are collected or received by a terminal device in real time;
acquiring instruction information generated by a user in operating a terminal device;
acquiring a text message input in a terminal device by a user;
acquiring information generated by a user's rocking a terminal device; and
acquiring information generated by a terminal device in capturing a user's gestures or postures.

12. The interactive method for the electronic device according to claim 10, wherein the interactive contents are carried in a data packet that comprises custom fields associated with the interactive contents.

13. The interactive method for the electronic device according to claim 12, wherein transmitting a connection request to the electronic device so as to establish communication connection with the electronic device comprises:
transmitting a first broadcasting message in order for the electronic device to find the first broadcasting message;
receiving a second broadcasting message that is transmitted by the electronic device in response to finding the first broadcasting message;
providing, in response to the reception of the second broadcasting message, information related to the electronic device for a user so that the user can determine whether to select the electronic device; and
transmitting the connection request to the electronic device in response to the user's selecting of the electronic device so as to establish communication connection with the electronic device.

14. An electronic device, comprising:
a memory storing computer executable program codes;
a communication interface; and
a processor, coupled with the memory and the communication interface;
wherein the program codes comprises instruction which, when executed by the processor, cause the processor to:
establish communication connection with another device;
create a transparent display layer above a display interface of the electronic device;
receive interactive contents from the another device; and
display the interactive contents in the transparent display layer.

15. The electronic device according to claim 14, wherein the instructions which, when executed by the processor, cause the processor to:
inquire about whether another device exists in a local area network;
transmit a broadcasting message in a case where another device exists;
configured to receive a connection request from the another device; and
establish communication connection with the another device in response to a connection request.

16. The electronic device according to claim 14, wherein the interactive contents are carried in a data packet that includes custom fields associated with the interactive contents.

17. The electronic device according to claim 14, wherein the instructions which, when executed by the processor, cause the processor to:
analyze the received interactive contents on the basis of the custom fields; and
display the analyzed interactive contents in the transparent display layer.

18. The electronic device according to claim 14, wherein the instructions which, when executed by the processor, cause the processor to:
render the interactive contents in the transparent display layer.

19. The electronic device according to claim 14, wherein the program codes further comprise the instructions which, when executed by the processor, cause the processor to:
acquire features of contents that are being broadcasted in the display interface of the electronic device;
determine a current take-up situation of system resources of the electronic device on the basis of the features; and
adjust the way of displaying the interactive contents in accordance with the take-up situation of the system resources.

20. The electronic device according to claim 19, wherein the instructions which, when executed by the processor, cause the processor to:
display the interactive contents ambiguously or reduces a size of the transparent display layer when the occupancy of the system resources is greater than 80%.
